(19) United States
(12) Patent Application Publication
(10) Pub. No.: US 2024/0349952 A1
(43) Pub. Date: Oct. 24, 2024

(54) Bath Tub Equipped with Magnetic Oscillation Mechanism for Refining Water Molecules

(71) Applicant: Kuo-Hua Lu, Taipei (TW)

(72) Inventor: Kuo-Hua Lu, Taipei (TW)

(21) Appl. No.: 18/399,691

(22) Filed: Dec. 29, 2023

(30) Foreign Application Priority Data
Apr. 21, 2023 (TW) 112114989

(51) Int. Cl. A47K 3/02; C02F 1/48; C02F 103/42

(52) U.S. Cl. CPC A47K 3/02; C02F 1/48; C02F 2103/42; C02F 2201/483

(57) ABSTRACT

A bath tub equipped with magnetic oscillation mechanism for refining water molecules include a bath tub and a magnetic oscillation refining mechanism for water molecules. The mechanism is primarily set around the bath tub and is capable of directly utilizing an alternating current power source or converting a direct current power source into an alternating current power source to drive the oscillation of an alternating magnetic field. This magnetic oscillation refining mechanism generates oscillations that refine and activate the water molecules within the bath tub, making them more easily absorbed by the human body. This offers benefits to the bather's skin, such as moisturizing, maintaining elasticity without tightness, and promoting smoothness and finesse.

### TECHNICAL FIELD

This invention pertains to the technical field of bathing equipment, specifically to a bath tub equipped with a mechanism for refining water molecules through magnetic oscillation.

### BACKGROUND ART

In modern society, there is an increasing focus on health and beauty, and bathing is a common way to relax, relieve stress, and improve sleep. With technological advancements, people have higher expectations for their bathing experience, seeking more comfortable and healthier bathing.

Most bath tubs on the market simply provide a container for storing water. While water can relax muscles and reduce fatigue, the microbes and impurities in water also pose a threat to human health. Water contains many chemicals, such as chlorine, radium, and fluoride, which can volatilize at high temperatures and react with other substances to form harmful compounds, thereby threatening human health.

Additionally, water contains trace elements like magnesium and calcium, which can affect the skin and health during bathing. For example, long-term bathing in hard water can cause skin dryness, roughness, or even dermatitis, affecting the bathing experience and health.

Consequently, many people add chemical agents to the bath water to disinfect and purify it, but this not only disrupts the molecular structure of the water but can also harm the human body.

In view of this, the purpose of this creation is to overcome these problems by developing a bath tub that uses an alternating magnetic field to refine water molecule clusters through magnetic oscillation. This improves the quality of the water, making bathing more comfortable and healthy, addressing the deficiencies of the known technology, and enhancing the added value and practicality of the bath tub.

### SUMMARY

To solve the aforementioned problems and achieve the objectives of this invention, the technical solution is realized as follows: a bath tub with a mechanism for refining water molecules through magnetic oscillation, characterized by including a bath tub; and a magnetic oscillation refining mechanism positioned on one side of the bath tub. The magnetic oscillation refining mechanism includes a housing, one side of which can fit against the corresponding wall of the bath tub, and has at least one through-hole located on the side of the housing opposite the bath tub; a heat dissipation fan, positioned corresponding to the through-hole; a water molecule refining device, located inside the housing and connected to the heat dissipation fan, comprising a box body and several magnetic field generators located inside the box body. The box body consists of a plate body and a cover covering the plate body. The cover has several heat dissipation holes corresponding to the heat dissipation fan. The magnetic field generator consists of a U-shaped magnetic conductor made of metal material and positioned on both sides of the plate body, two isolation sleeves positioned at the protruding ends of the magnetic conductor, and two exciting coil parts respectively wound around the isolation sleeves. The open end of the magnetic conductor corresponds to the plate body, while the closed end is positioned on the cover; and a power switch, positioned on one side of the top end of the housing, electrically connected to the water molecule refining devices and the heat dissipation fan, for controlling the input of AC power from the mains.

Preferably, on the surface of the cover, at both side edges, several exhaust holes are equally spaced, and at the corresponding position of the heat dissipation hole, a recessed part is set.

More preferably, on the side of the housing corresponding to the heat dissipation fan, several ventilation holes corresponding to the exhaust holes are spaced apart.

Even more preferably, the magnetic oscillation refining mechanism is further equipped with an F-shaped protective cover. The notch end of the protective cover corresponds to the heat dissipation fan, and the top and bottom ends of the side walls of the protective cover are movably connected to the magnetic oscillation refining mechanism. An air channel is formed between the protective cover and the housing, allowing for the airflow from the heat dissipation fan and the ventilation holes to circulate in and/or out.

Preferably, at the bottom end connection of the side walls of the protective cover, at least one guide groove is set for adjusting the angle of the magnetic oscillation refining mechanism, so that it can fit closely against the corresponding wall of the bath tub.

More preferably, on the closed end of the protective cover, a handle is set for the convenience of the user to move the magnetic oscillation refining mechanism.

Preferably, the water molecule refining device also includes a buffer pad positioned between each magnetic field generator and the plate body.

Preferably, the isolation sleeve is made up of a hollow shaft around which the exciting coil part is wound, and upper and lower blocking walls positioned at both ends of the hollow shaft. The isolation sleeve is made of plastic, stainless steel, aluminum, copper material, or a combination thereof.

Preferably, the power switch is also electrically connected to a power cord extending outside the housing, which can be connected to the mains to obtain AC power.

Preferably, on one side of the bath tub, the upper edge forms an upward extending pillow part, and the magnetic oscillation refining mechanism is positioned against the bottom end of the pillow part, so that one side of it can fit closely against the corresponding wall of the bath tub.

By implementing the above aspects of this invention, the following functions and effects are achieved:

Firstly, the magnetic oscillation refining mechanism of this invention can refine the molecular clusters of water in the bath tub, enhancing the penetration and dissolution abilities of the water molecules, improving the quality of the water in the bath tub. This allows the water molecules to better penetrate the skin pores of the bather, thoroughly cleansing the skin, helping to improve skin problems and maintain good skin health, and promoting blood circulation and muscle relaxation, making bathing more comfortable and healthier.

Secondly, through the setting of the heat dissipation fan and the air channel, the invention can effectively dissipate the heat generated by the water molecule refining device, effectively reducing the internal temperature of the device, thus maintaining its operational efficiency and stability.

Thirdly, through the setting of the protective cover, the invention not only effectively protects the magnetic oscillation refining mechanism from external damage or contamination, thereby prolonging its service life, but also stabilizes the position of the mechanism, preventing unnecessary shaking or displacement during use, thus ensuring stable and lasting effectiveness.

Fourthly, through the setting of the guide groove, the invention allows for the adjustment of the angle of the magnetic oscillation refining mechanism, facilitating better alignment with the surface of the bath tub, thus increasing the contact area and improving the magnetization effect.

Fifthly, the invention, through the U-shaped magnetic conductor, in conjunction with the isolation sleeve and the exciting coil part, produces a stable and even magnetic field, with strong magnetic lines and effective magnetization.

Sixthly, through the setting of the power switch, the invention allows the water molecule refining device and the heat dissipation fan to operate instantly, providing quick response and convenient control for the user, enhancing ease of use.

### BRIEF DESCRIPTION OF THE DRAWINGS

FIG. 1 is a perspective view of the present invention;

FIG. 2 is an exploded view of the present invention;

FIG. 3 is an exploded view of the water molecule refining device in the present invention;

FIGS. 4 and 5 are Cross-sectional implementation views of the present invention.

### DETAILED DESCRIPTION OF THE EMBODIMENTS

To further understand the features, technical means, and specific objectives and functions achieved by the present invention, the following detailed description is provided in conjunction with the accompanying drawings and specific embodiments.

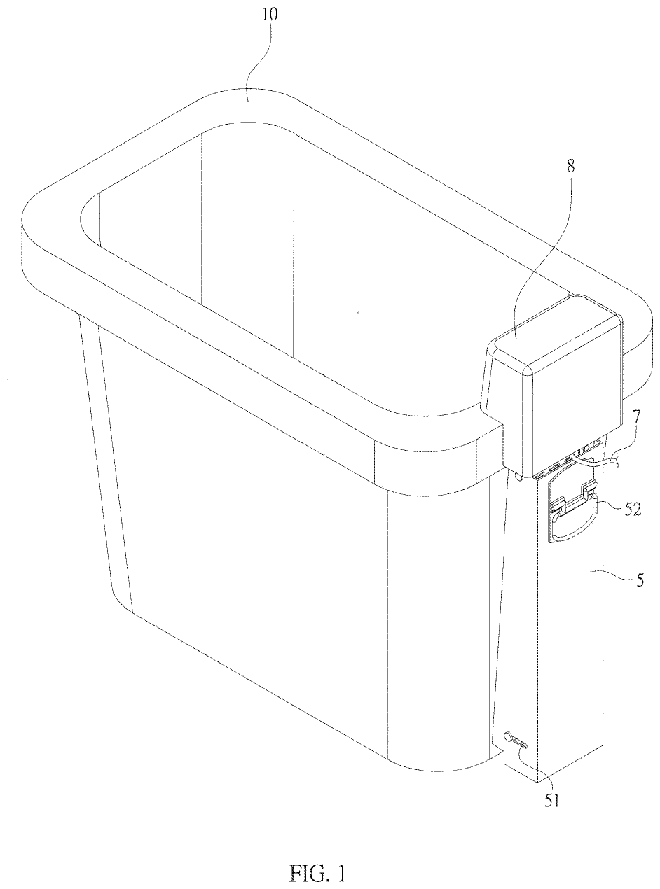

As shown in FIGS. 1 to 3, the invention reveals a bath tub equipped with a magnetic oscillation refining mechanism for water molecules. The tub is characterized by including: a bath tub (10); and a magnetic oscillation refining mechanism (20) set on one side of the bath tub (10). The magnetic oscillation refining mechanism (20) includes: a housing (1), one side of which can fit against the corresponding wall of the bath tub (10), and has at least one through-hole (11) on the side facing away from the bath tub (10); a heat dissipation fan (2), positioned corresponding to the through-hole (11); a water molecule refining device (3), located inside the housing (1) and connected to the heat dissipation fan (2). This device includes a box body (31) and several magnetic field generators (32) within the box body (31). The box body (31) consists of a plate body (311) and a cover (312) covering the plate body (311). The cover (312) has several heat dissipation holes (3121) corresponding to the heat dissipation fan (2). The magnetic field generator (32) is made up of a U-shaped magnetic conductor (321) positioned on both sides of the plate body (311), two isolation sleeves (322) positioned at the protruding ends of the magnetic conductor (321), and two exciting coil parts (323) respectively wound around the isolation sleeves (322). The open end of the magnetic conductor (321) corresponds to the plate body (311), while the closed end is located on the cover (312); and a power switch (4), positioned on one side of the top end of the housing (1) and electrically connected to the water molecule refining devices (3) and the heat dissipation fan (2) for controlling the input of AC power from the mains.

In the above, the use of the magnetic oscillation refining mechanism (20) in conjunction with the bath tub (10) can refine the molecular clusters of water in the bath tub (10), enhancing the penetration and dissolution abilities of the water molecules, improving the quality of the water in the bath tub (10). This allows the water molecules to better penetrate the skin pores of the bather, thoroughly cleansing the skin, helping to improve skin problems and maintain good skin health, and promoting blood circulation and muscle relaxation, making bathing more comfortable and healthier.

The U-shaped magnetic conductor (321), in conjunction with the isolation sleeves (322) and the exciting coil parts (323), produces a stable and evenly distributed magnetic field, with strong magnetic lines and effective magnetization.

Furthermore, the setting of the power switch (4) allows the water molecule refining device (3) and the heat dissipation fan (2) to operate instantly, providing quick response and convenient control for the user, enhancing ease of use.

Additionally, the magnetic field generator (32), when combined with AC power, aligns in the same direction to create an alternating magnetic field. At 50 Hz or 60 Hz, the magnetic field generator (32) constantly changes the polarity of the S and N poles, producing a rapidly changing magnetic line cutting effect. This process breaks the bonds of large molecular clusters of water in the bath tub (10), forming small molecular clusters of water.

The overall structure of these small molecular clusters is minute, reaching nanometer scale, and exhibits different physical and chemical properties. They perform better than large molecular clusters in their normal state.

Through a powerful alternating magnetic field, large molecular clusters (H2O) n are divided by the magnetic field into diatomic [H2O]2 or monatomic H2O. After magnetization, the angle of the hydrogen-oxygen bond in water molecules is reduced from 104.5° to about 103°, changing the direction and increasing the value of the interatomic magnetic distance, thereby altering the fluid's properties.

Using the magnetic energy of the alternating magnetic field to activate water molecules transforms large molecular clusters into small ones, creating magnetized [small molecule] activated water. The water in the bath tub (10), with its molecular clusters refined, will be smaller than typical molecules, enhancing their penetration and dissolution abilities, improving the quality of the water in the bath tub (10). Since water molecules [H2O] are themselves small magnets, due to the magnetic characteristic of like repelling like and unlike attracting, the originally attractive large [13 to 23 molecule] water clusters are reorganized and rearranged under the strong alternating magnetic field. The energized water molecules, like spinning tops, accelerate in rotation, breaking the hydrogen bonds that hold the water molecule clusters together, forming individual polar water molecules, thus refining the molecular clusters and changing the water's hardness, increasing its activity, oxygen content, permeability, solubility, and more.

After the powerful alternating magnetic field, the properties are as follows: After the powerful alternating magnetic field, the water molecule bonds undergo changes in angle and length [103 to 105], causing significant physical and chemical changes in the water. Calcium bicarbonate and magnesium bicarbonate [CaCO3, MgCO3] decompose into softer substances during boiling, making them less likely to accumulate on surfaces and easier to be carried away by water molecules, thus degrading residual chlorine and preventing scaling. This also enhances the permeability of biofilms, changes the pH to weakly alkaline, and stimulates the activity of enzymes in water.

Generally, the chlorine in tap water exists in a free state with strong activity, not reacting chemically with water. However, under the strong stimulation of the alternating magnetic field, chlorine gas and water are activated into hydrochloric acid and hypochlorous acid, which then decomposes into hydrochloric acid and nascent oxygen.

Nascent oxygen has a strong oxidizing effect, capable of disinfection and algae elimination. After the dissociation of hydrochloric acid, chlorine ions and hydrogen ions are formed. Thus, the originally free chlorine becomes chlorine ions. Chlorine ions combine with potassium, calcium, magnesium, and other metal ions in the water to form potassium salt, sodium salt, calcium salt, magnesium salt, rendering harmful residual chlorine harmless. This is the distinction of water treated under the alternating magnetic field.

As shown in FIG. 1, the power switch (4) is also electrically connected to a power cord (7) extending outside the housing (1). The power cord (7) can be connected to the mains to obtain AC power.

In the above, the use of the power cord (7) allows the magnetic oscillation refining mechanism (20) of the present invention to obtain stable AC power from the mains, enabling the magnetic field generator (32) and the heat dissipation fan (2) to operate smoothly.

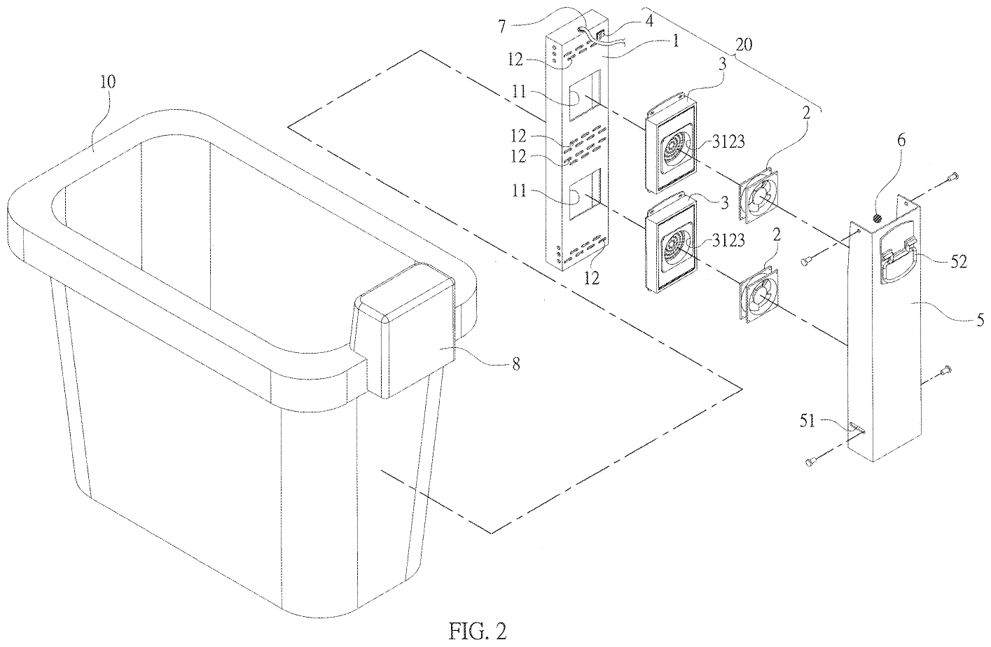

As shown in FIG. 2, the housing (1) corresponding to the heat dissipation fan (2) is also intermittently arranged with several ventilation holes

(12) corresponding to the exhaust holes (3122).

In the above, the corresponding arrangement of the ventilation holes (12) and the exhaust holes (3122) effectively promotes air circulation, thereby improving heat dissipation. The ventilation holes (12) on the housing (1) also prevent dust and other debris from entering the water molecule refining device (3), effectively prolonging its service life.

Additionally, the arrangement of the ventilation holes (12) in conjunction with the heat dissipation fan (2) stabilizes air flow, thereby reducing the noise generated during the operation of the heat dissipation fan (2).

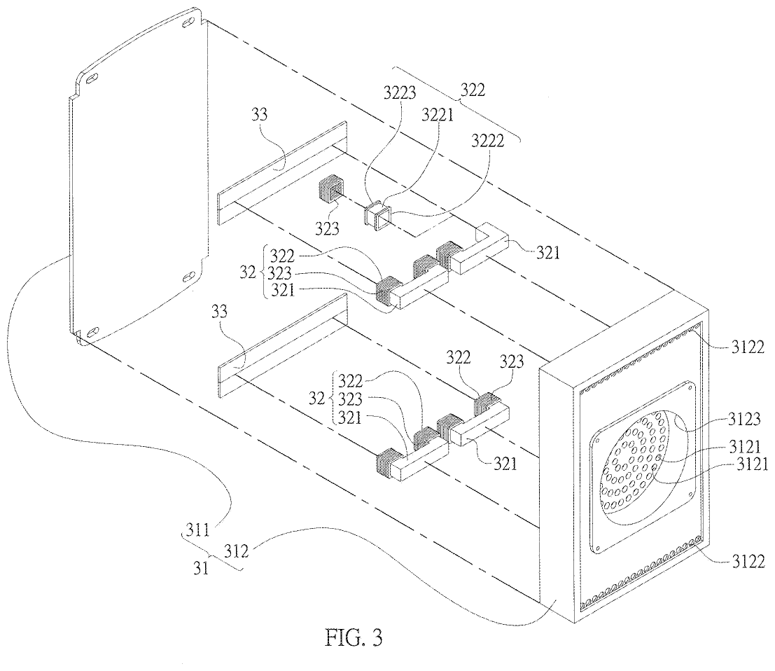

As shown in FIG. 3, the cover (312) surface at both side edges is equally spaced with several exhaust holes (3122), and at the position corresponding to the heat dissipation hole (3121), a recessed part (3123) is set.

In the above, the combined use of the heat dissipation hole (3121) and the recessed part (3123) increases the heat dissipation area of the water molecule refining device (3), thereby improving its heat dissipation effect and reducing the fault rate due to high temperatures.

Secondly, the setting of the exhaust holes (3122) prevents the internal pressure of the water molecule refining device (3) from becoming too high, thereby reducing the likelihood of faults.

As shown in FIG. 3, the water molecule refining device (3) also includes a buffer pad (33) positioned between each magnetic field generator (32) and the plate body (311).

In the above, the use of the buffer pad (33) ensures that the magnetic oscillation refining mechanism (20) of the present invention does not collide with the plate body (311) during movement or transportation, ensuring the normal operation of the magnetic field generator (32).

As shown in FIG. 3, the isolation sleeve (322) is composed of a hollow shaft (3221) around which the exciting coil part (323) is wound, and upper and lower blocking walls (3222, 3223) positioned at both ends of the hollow shaft (3221). The isolation sleeve (322) is made of plastic, stainless steel, aluminum, copper material, or a combination thereof.

In the above, the use of the isolation sleeve (322) not only provides a fixed function for the exciting coil part (323) but also has an insulating effect, preventing short circuits.

Secondly, without affecting the magnetic field, the use of isolation sleeves (322) made of different materials provides a more diverse range of magnetic field generators (32), offering more choices to users and expanding the application range.

As shown in FIGS. 2, 4, and 5, the magnetic oscillation refining mechanism (20) is further equipped with an F-shaped protective cover (5). The notch end of the protective cover (5) corresponds to the heat dissipation fan (2), and the top and bottom ends of the side walls of the protective cover (5) are movably connected to the magnetic oscillation refining mechanism (20). An air channel (6) is formed between the protective cover (5) and the housing (1), allowing for the airflow from the heat dissipation fan (2) and the ventilation holes (12) to circulate in and/or out.

In the above, the setting of the protective cover (5) not only effectively protects the magnetic oscillation refining mechanism (20) from external damage or contamination, thereby prolonging its service life, but also stabilizes the position of the mechanism, preventing unnecessary shaking or displacement during use, thus ensuring stable and lasting effectiveness.

Secondly, the combined setting of the heat dissipation fan (2) and the air channel (6) effectively dissipates or disperses the heat generated by the water molecule refining device (3), effectively reducing the internal temperature of the device, thus maintaining its operational efficiency and stability.

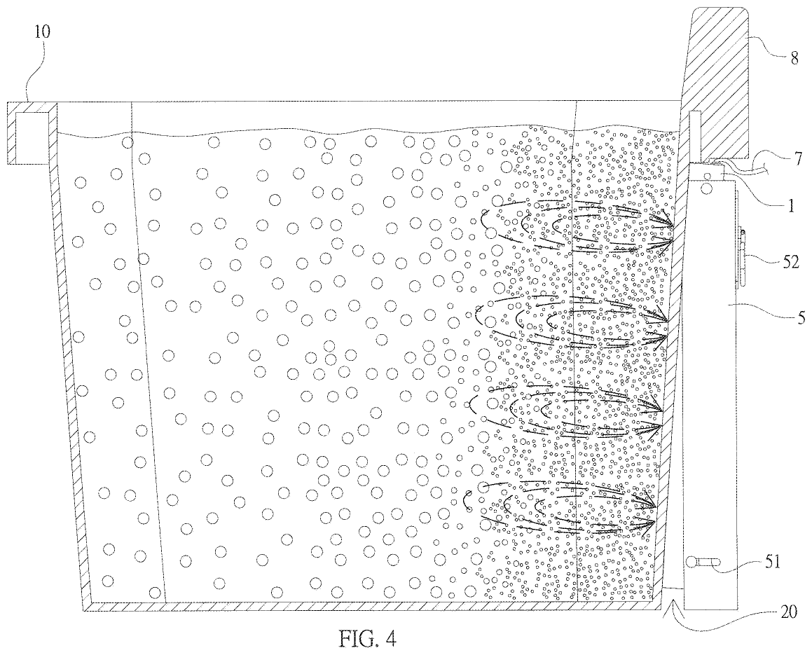

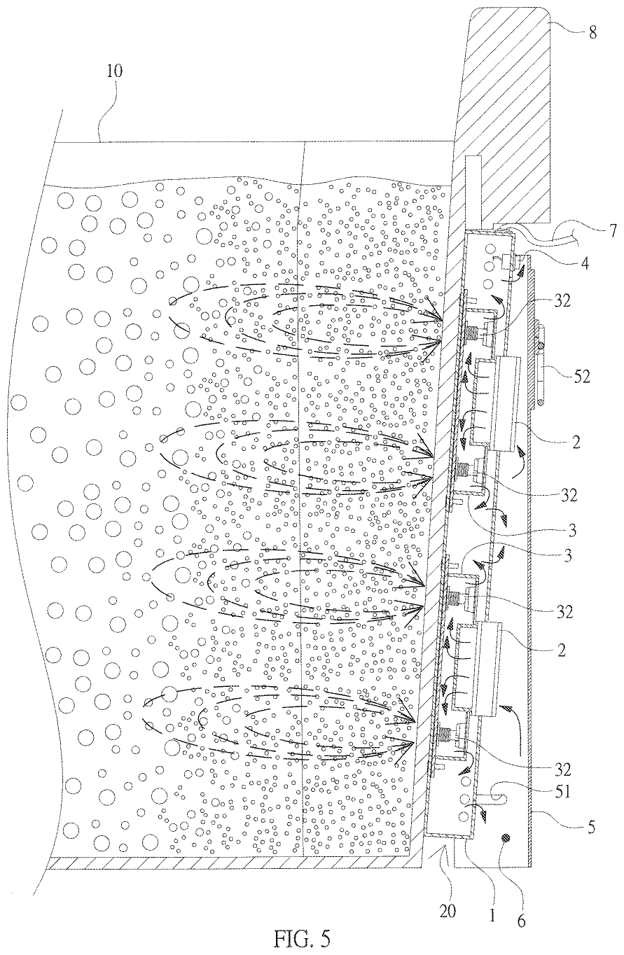

As shown in FIGS. 4 and 5, at least one guide groove (51) is set at the bottom end connection of the side walls of the protective cover (5) for adjusting the angle of the magnetic oscillation refining mechanism (20), so that it can fit closely against the corresponding wall of the bath tub (10) and better adhere to the surface of the bath tub (10), thereby increasing the contact area of the magnetic oscillation refining mechanism (20) and improving the magnetization effect.

As shown in FIGS. 4 and 5, a handle (52) is set on the closed end of the protective cover (5) for the convenience of the user to move the magnetic oscillation refining mechanism (20).

As shown in FIGS. 4 and 5, on one side of the bath tub (10), the upper edge forms an upward extending pillow part (8), and the magnetic oscillation refining mechanism (20) is positioned against the bottom end of the pillow part (8), so that one side of it can fit closely against the corresponding wall of the bath tub (10).

In the above, the combined use of the pillow part (8), the bath tub (10), and the magnetic oscillation refining mechanism (20) provides support for the bather's neck during bathing, reducing cervical pressure and making the bathing experience more comfortable. The close fitting of the magnetic oscillation refining mechanism (20) against the corresponding wall of the bath tub (10) increases its contact area, improving the magnetization effect on the water inside the bath tub (10), achieving the best possible refinement of water molecule clusters with a certain energy consumption, without the worry of incomplete refinement.

The structure, features, and effects of the present invention have been detailed above in accordance with the illustrated embodiment. However, the above description is only of the preferred embodiment of the present invention, and the scope of the invention is not limited to the embodiments shown in the drawings. Therefore, any decorative changes that conform to the spirit of the present invention and are within the range of equivalent effects should be included within the scope of this invention's patent.

I claim:

1. A bath tub equipped with a magnetic oscillation mechanism for refining water molecules, comprising:
a bath tub (10); and
a magnetic oscillation refining mechanism (20) for water molecules disposed on one side around the bath tub (10);
wherein the magnetic oscillation refining mechanism (20) includes
a housing (1), one side of which can fit against the corresponding wall of the bath tub (10), having at least one through-hole (11) on the side facing away from the bath tub (10);
a heat dissipation fan (2), positioned corresponding to the through-hole (11);
a water molecule refining device (3), located inside the housing (1) and connected to the heat dissipation fan (2), including a box body (31) and a plurality of magnetic field generators (32) within the box body (31); the box body (31) including a plate body (311) and a cover (312) covering the plate body (311); the cover (312) having a plurality of heat dissipation holes (3121) corresponding to the heat dissipation fan (2);
the magnetic field generator (32) is made up of a U-shaped magnetic conductor (321) positioned on both sides of the plate body (311), two isolation sleeves (322) positioned at the protruding ends of the magnetic conductor (321), and two exciting coil parts (323) respectively wound around the isolation sleeves (322); the open end of the magnetic conductor (321) corresponds to the plate body (311), while the closed end is located on the cover (312); and
a power switch (4), positioned on one side of the top end of the housing (1) and electrically connected to the water molecule refining devices (3) and the heat dissipation fan (2) for controlling the input of AC power from the mains.

2. The bath tub equipped with the magnetic oscillation mechanism for refining water molecules according to claim 1, wherein the cover (312) surface at both side edges is equally spaced with a plurality of exhaust holes (3122), and at the position corresponding to the heat dissipation hole (3121), a recessed part (3123) is set.

3. The bath tub equipped with the magnetic oscillation mechanism for refining water molecules according to claim 1, wherein the housing (1) corresponding to the heat dissipation fan (2) is also intermittently arranged with several ventilation holes (12) corresponding to the exhaust holes (3122).

4. The bath tub equipped with the magnetic oscillation mechanism for refining water molecules according to claim 1, wherein the magnetic oscillation refining mechanism (20) is further equipped with an F-shaped protective cover (5); the notch end of the protective cover (5) corresponds to the heat dissipation fan (2), and the top and bottom ends of the side walls of the protective cover (5) are movably connected to the magnetic oscillation refining mechanism (20); an air channel (6) is formed between the protective cover (5) and the housing (1), allowing for the airflow from the heat dissipation fan (2) and the ventilation holes (12) to circulate in and/or out.

5. The bath tub equipped with the magnetic oscillation mechanism for refining water molecules according to claim 4, wherein at least one guide groove (51) is set at the bottom end connection of the side walls of the protective cover (5) for adjusting the angle of the magnetic oscillation refining mechanism (20), so that it can fit closely against the corresponding wall of the bath tub (10).

6. The bath tub equipped with the magnetic oscillation mechanism for refining water molecules according to claim 4, wherein a handle (52) is disposed on the closed end of the protective cover (5) for the convenience of the user to move the magnetic oscillation refining mechanism (20).

7. The bath tub equipped with the magnetic oscillation mechanism for refining water molecules according to claim 1, wherein the water molecule refining device (3) also includes a buffer pad (33) positioned between each magnetic field generator (32) and the plate body (311).

8. The bath tub equipped with the magnetic oscillation mechanism for refining water molecules according to claim 1, wherein the isolation sleeve (322) is composed of a hollow shaft (3221) around which the exciting coil part (323) is wound, and upper and lower blocking walls (3222, 3223) positioned at both ends of the hollow shaft (3221); the isolation sleeve (322) is made of plastic, stainless steel, aluminum, copper material, or a combination thereof.

9. The bath tub equipped with the magnetic oscillation mechanism for refining water molecules according to claim 1, wherein the power switch (4) is also electrically connected to a power cord (7) extending outside the housing (1); the power cord (7) can be connected to the mains to obtain AC power.

10. The bath tub equipped with the magnetic oscillation mechanism for refining water molecules according to claim 1, wherein on one side of the bath tub (10), the upper edge forms an upward extending pillow part (8), and the magnetic oscillation refining mechanism (20) is positioned against the bottom end of the pillow part (8), so that one side of it can fit closely against the corresponding wall of the bath tub (10).
